(19) United States
(12) Patent Application Publication
(10) Pub. No.: US 2003/0228129 A1
(43) Pub. Date: Dec. 11, 2003

(54) Apparatus and method for playing image signal

(75) Inventor: Sung-soo Kim, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/391,183

(22) Filed: Mar. 19, 2003

(30) Foreign Application Priority Data
Mar. 19, 2002 (KR) 2002-14849

(51) Int. Cl. H04N 5/91

(52) U.S. Cl. 386/46

(57) ABSTRACT

An apparatus and a method for playing an image signal, by which an input digital image signal can be permanently stored and information that has been previously stored for a predetermined amount of time can be viewed again upon demand, are provided. The apparatus includes a storage unit in which an externally-input digital image signal is stored, a selection unit which directly selects the externally-input digital image signal in response to a switching control signal or selects a digital image signal output from the storage unit, and a control unit which outputs the switching control signal in response to a replay mode off signal used to select the externally-input digital image signal and outputs the switching control signal used to stop storage of the storage unit and select a predetermined duration of the digital image signal stored in the storage unit in response to the replay mode on signal.

### BACKGROUND OF THE INVENTION

This application claims the priority of Korean Patent Application No. 2002-14849, filed on Mar. 19, 2002, in the Korean Intellectual Property Office, the disclosure of which is incorporated herein in its entirety by reference.

1. Field of the Invention

The present invention relates to an apparatus and a method for playing an image signal, and more particularly, to an apparatus and a method for playing an image signal, by which an input digital image signal can be permanently stored and information that has been previously stored for a predetermined amount of time can be viewed again at a viewer's request.

2. Description of the Related Art

Recently, in TVs, a double screen or a multi-screen can be displayed using technologies such as picture-in-picture (PIP) and picture-out-picture (POP). Thus, at least two different channels can be simultaneously viewed. Also, when a user who views an input image or listens to audio information wants to view desired information again, in a typical replay medium, the user stores the information for a predetermined amount of time and then views the desired information again. That is, when a viewer wants to store the input image or audio information, the viewer can store information corresponding to a predetermined amount of time and view desired information of the stored information. However, when the user watches a TV without storing input image or audio information, and later wants to view information, there is no information that has been previously stored, causing some inconveniences.

### SUMMARY OF THE INVENTION

The present invention provides an apparatus for playing an image signal, by which an input digital image signal can be permanently stored and information that has been previously stored for a predetermined amount of time can be viewed again upon demand.

The present invention further provides a method for playing an image signal, by which an input digital image signal can be permanently stored and information that has been previously stored for a predetermined amount of time can be viewed again upon demand.

According to an aspect of the present invention, there is provided an apparatus for playing a selected digital image signal by decoding the selected digital image signal. The apparatus includes a storage unit in which an externally-input digital image signal is stored, a selection unit which directly selects the externally-input digital image signal in response to a switching control signal or selects a digital image signal output from the storage unit, and a control unit which outputs the switching control signal in response to a replay mode off signal used to select the externally-input digital image signal and outputs the switching control signal used to stop storage of the storage unit and select a predetermined duration of the digital image signal stored in the storage unit in response to the replay mode on signal.

The apparatus further includes a synchronism conversion unit which synchronizes the digital image signal input to/output from the storage unit with the externally-input digital image signal.

The control unit senses a storage capacity of the storage unit, and if a storage region of the storage unit is filled with the digital image signal, the control unit outputs an overwrite control signal to the storage unit and controls a next digital image signal to be stored from the initial part of the storage unit again. The control unit receives a replay time signal input by the user and reads a predetermined duration of the storage unit for a replay time, and controls a signal read from the storage unit to be replayed until the replay mode off signal is received.

According to another aspect of the present invention, there is provided a method for playing an image signal. The method comprises (a) transmitting an externally-input digital image signal to a decoder and simultaneously storing the digital image signal in a memory, and (b) if a replay mode signal is received during step (a), stopping step (a) and outputting a predetermined duration of the digital image signal stored in the memory to the decoder.

The digital image signal input to/output from the memory is synchronized with the externally-input digital image signal.

In step (a), if the memory is filled with the stored externally-input digital image signal, a next externally-input digital image signal is stored by overwriting starting from an initial part of the memory.

In step (b), a replay time signal input by the user is received, a predetermined duration of the storage unit is read for a replay time, and a signal read from the storage unit is controlled to be replayed until the replay mode off signal is received.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram illustrating the structure of an apparatus for playing an image signal according to the present invention;

FIG. 2 is a flow chart illustrating a method for playing an image signal according to the present invention; and

FIG. 3 is a detailed diagram illustrating the step of setting a replay mode to on/off and operating the apparatus in that replay mode of FIG. 2.

### DETAILED DESCRIPTION OF THE INVENTION

Hereinafter, the present invention will be described in detail with reference to the accompanying drawings.

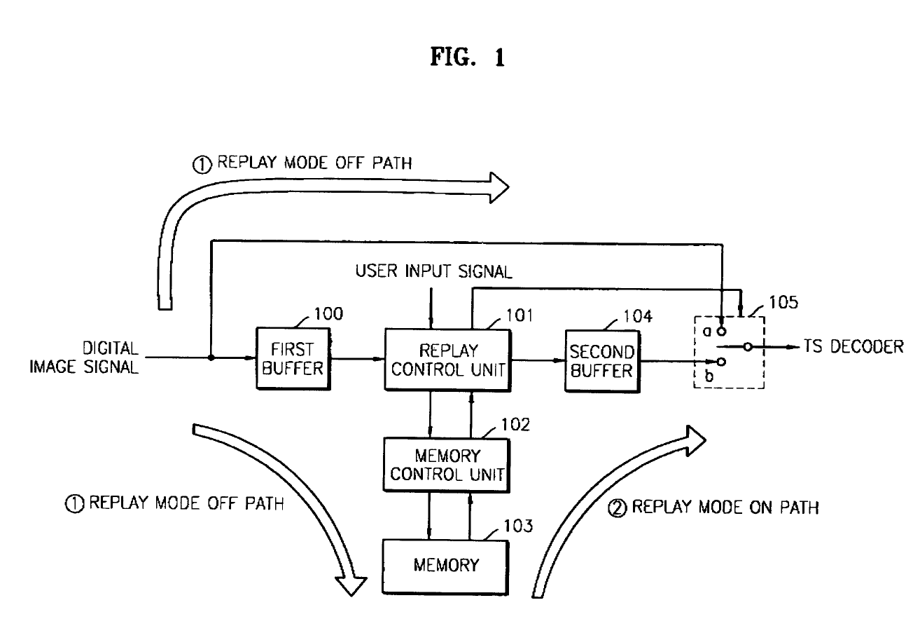

FIG. 1 is a block diagram illustrating the structure of an apparatus for playing an image signal according to the present invention. The apparatus for playing an image signal according to the present invention includes a first buffer 100, a replay control unit 101, a memory control unit 102, a memory (storage unit) 103, a second buffer 104, and a switching unit 105.

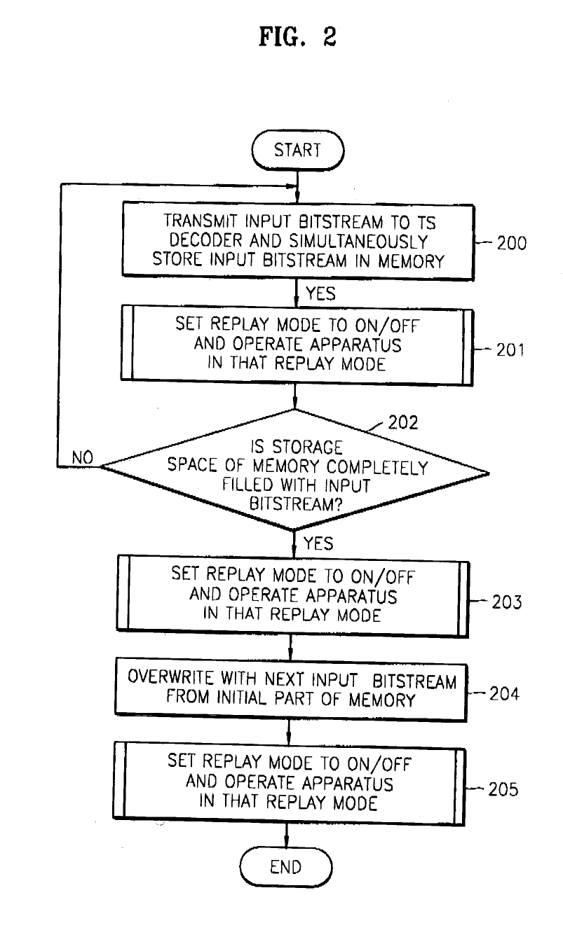

FIG. 2 is a flow chart illustrating a method for playing an image signal according to the present invention. The method for playing an image signal according to the present invention comprises the steps of transmitting an input bitstream to a TS (transport stream) decoder (not shown) and simultaneously storing the input bitstream in a memory (step 200), setting a replay mode to on/off and operating the apparatus in the replay mode setting (step 201), determining whether a storage space of the memory is completely filled with the input bitstream (step 202), setting a replay mode to on/off and operating the apparatus in the replay mode setting (step 203), overwriting with a next input bitstream from an initial part of the memory (step 204), and setting a replay mode to on/off and operating the apparatus in the replay mode setting (step 205).

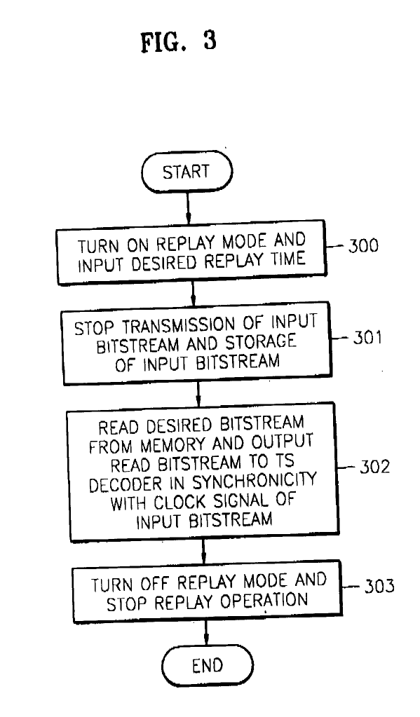

FIG. 3 is a detailed diagram illustrating the step of setting a replay mode to on/off and operating the apparatus in the replay mode setting of FIG. 2. The step of operating the apparatus in the replay mode setting comprises steps of turning on the replay mode and inputting a desired replay time (step 300), stopping a transmission operation of the input bitstream and stopping storage of the input bitstream in the memory (step 301), reading a desired bitstream from the memory and outputting the bitstream to the TS decoder in synchronicity with a clock signal of the input bitstream (step 302), stopping a replay operation and turning off the replay mode (step 303).

The present invention will be described in greater detail below with reference to FIGS. 1 through 3.

The first buffer 100 performs a buffering operation so as to synchronize an input digital image signal with a digital image signal processed by the replay control unit 101, the memory control unit 102, and the memory 103. If the input digital image signal is already synchronized with the digital image signal processed by the replay control unit 101, the memory control unit 102, and the memory 103, the buffering operation of the first buffer 100 is not needed.

Similarly, the second buffer 104 performs a buffering operation so as to synchronize the digital image signal processed by the replay control unit 101, the memory control unit 102, and the memory 103 with a digital image signal output to the TS decoder (not shown). Also, if the digital image signal processed by the replay control unit 101, the memory control unit 102, and the memory 103 is already synchronized with the digital image signal output to the TS decoder, the buffering operation of the second buffer 104 is not needed.

The present invention operates through two paths: a replay mode off path marked \mathring{1} in FIG. 1 and a replay mode on path marked \mathring{2} in FIG. 1. A replay mode on/off signal is input by a user and received by the replay control unit 101.

In the case of the replay mode off path marked \mathring{1} in FIG. 1, the replay mode off signal may be input by the user, or a play apparatus may be operated, causing the replay mode to be automatically set to an off state. In the replay mode off state, the replay control unit 101 outputs a switching control signal to allow the switching unit 105 to be switched to a so as to transmit an input digital image signal to the TS decoder. If the switching unit 105 is switched to a in response to the switching control signal, the input digital image signal is transmitted directly to the TS decoder, is decoded, and then is output as a view signal. In the replay mode off state, the replay control unit 101 transmits the input digital image signal to the TS decoder and simultaneously controls storage of the input digital image signal in the memory 103. The replay control unit 101 senses the storage capacity of the memory 103, and if a storage region of the memory 103 is filled with the input digital image signal, the replay control unit 101 overwrites with a next input digital image signal starting from an initial part of the memory 103. The memory control unit 102 controls a read/write operation of the memory 103 under the control of the replay control unit 101.

In the case of the replay mode on path marked \mathring{2} in FIG. 1, the replay mode on signal is input by the user and received by the replay control unit 101 to turn on the replay mode. In a replay mode on state, the replay control unit 101 stops transmission operation of the input digital image signal to the TS decoder and storage of the input digital image signal in the memory 103. In the replay mode on state, the replay control unit 101 controls the operation of the memory 103 through a direct memory access (DMA) operation. The replay control unit 101 outputs a switching control signal used to switch the switching unit 105 to b so that the digital image signal stored in the memory 103 is output to the TS decoder. If the switching unit 105 is switched to b in response to the switching control signal, the digital image signal stored in the memory 103 is output to the TS decoder. In the replay mode on state, the replay control unit 101 has the following two functions: it receives a replay time signal input by the user and reads a predetermined duration of the memory 103 for a replay time, and controls a signal read from the memory 103 to be replayed until a replay mode off signal is received. The read digital image signal is input to the TS decoder through the switching unit 105 switched to b, is decoded, and then is output as a view signal.

The replay operation of the digital image signal may be performed whenever the user wants, regardless of storage of the memory 103, and thus may start from the time the replay mode on signal is input until the replay control unit 101 receives the replay mode off signal.

The method for playing an image signal according to the present invention will be described below with reference to FIGS. 2 and 3. In step 200, an input bitstream is transmitted to the TS decoder and simultaneously stored in the memory 103. Here, the input bitstream is the same as the input digital image signal of FIG. 1. Step 200 is the same as operating the apparatus of FIG. 1 through the replay mode off path.

In step 201, while the input bitstream is being transmitted to the TS decoder and simultaneously stored in the memory 103, the apparatus is operated in the replay mode set by a user's input.

FIG. 3 is a flowchart showing the steps of setting a replay mode to on/off and operating the apparatus in the replay mode setting of FIG. 2. In step 300, while the input bitstream is transmitted to the TS decoder and simultaneously stored in the memory 103, if the user wants a replay operation, the replay mode is turned on, and a desired replay time is input. In step 301, transmission of the input bitstream and storage of the input bitstream in the memory 103 are stopped. In step 302, if transmission and storage of the bitstream are stopped, the replay control unit 101 reads a desired bitstream from the memory 103 and then outputs the read bitstream to the TS decoder in synchronicity with a clock signal synchronized with the input bitstream. In the replay mode on state, the replay control unit 101 has the following two functions: it receives a replay time signal input by the user and reads a predetermined duration of the memory 103 for a replay time, and controls a signal read from the memory 103 to be replayed until a replay mode off signal is received. The read bitstream is input to the TS decoder, and then is decoded and output as a replay view signal. Subsequently, in step 303, if the replay mode off signal is input by the user, the replay operation is stopped.

In steps 202 and 203, it is determined whether the storage space of the memory 103 is completely filled with the input bitstream. If the storage space of the memory 103 is not completely filled with the input bitstream, the method goes to step 200, and if the storage space of the memory 103 is completely filled with the input bitstream, the apparatus is operated in the replay mode setting upon demand by the user. The apparatus can be operated in the replay mode setting whenever the user wants, regardless of the storage level of the bitstream in the memory 103.

In step 204, if the storage space of the memory 103 is not completely filled with the input bitstream, a next input bitstream is stored by overwriting starting from an initial part of the memory 103.

Anytime after or during overwriting of the bitstream in the memory 103, the user may set the replay mode to on/off again and operate the apparatus in the replay mode setting, in step 205.

As described above, according to the present invention, an input digital image signal can be permanently stored and information that has been previously stored for a predetermined amount of time can be viewed again upon demand such that user can watch TV conveniently.

While this invention has been particularly shown and described with reference to preferred embodiments thereof, it will be understood by those skilled in the art that various changes in form and details may be made therein without departing from the spirit and scope of the invention as defined by the appended claims and equivalents thereof.

What is claimed is:

1. An apparatus for playing a selected digital image signal by decoding the selected digital image signal, the apparatus comprising:
a storage unit in which an externally-input digital image signal is stored;
a selection unit which directly selects the externally-input digital image signal in response to a first switching control signal or selects a digital image signal output from the storage unit in response to a second switching control signal; and
a control unit which outputs the first switching control signal in response to a replay mode off signal used to select the externally-input digital image signal and outputs the second switching control signal used to stop storage of the storage unit and select a predetermined duration of the digital image signal stored in the storage unit in response to a replay mode on signal.

2. The apparatus of claim 1, further comprising a synchronism conversion unit which synchronizes at least one of the digital image signal input and the digital signal output from the storage unit with the externally-input digital image signal.

3. The apparatus of claim 1, wherein the control unit senses a storage capacity of the storage unit, and if a storage region of the storage unit is filled with the digital image signal, the control unit outputs an overwrite control signal to the storage unit and controls a next digital image signal to be stored from an initial part of the storage unit.

4. The apparatus of claim 1, wherein the control unit receives a replay time signal input by a user and reads the predetermined duration of the storage unit for a replay time, and controls the digital image signal read from the storage unit to be replayed until the replay mode off signal is received.

5. A method for playing an image signal, the method comprising:
(a) transmitting an externally-input digital image signal to a decoder and simultaneously storing the externally-input digital image signal in a memory; and
(b) if a replay mode on signal is received during step (a), stopping step (a) and outputting a predetermined duration of a digital image signal stored in the memory to the decoder.

6. The method of claim 5, wherein at least one of the digital image signal input to and the digital image signal output from the memory is synchronized with the externally-input digital image signal.

7. The method of claim 5, wherein, in step (a), if the memory is filled with the stored externally-input digital image signal, a next externally-input digital image signal is stored by overwriting the stored digital image signal starting from an initial part of the memory.

8. The method of claim 5, wherein in step (b), a replay time signal input by a user is received, the predetermined duration of the storage unit is read for a replay time, and the digital image signal read from the storage unit is controlled to be replayed until a replay mode off signal is received.
